(19) United States
(12) Patent Application Publication
(10) Pub. No.: US 2002/0000720 A1
(43) Pub. Date: Jan. 3, 2002

(54) Washdown system

(76) Inventor: L. James Knowles, Wilmington, NC (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/789,312

(22) Filed: Feb. 20, 2001

Related U.S. Application Data
(60) Provisional application No. 60/213,046, filed on Jun. 21, 2000.

(51) Int. Cl. F16L 37/00

(52) U.S. Cl. 285/308; 285/305; 138/109; 138/177

(57) ABSTRACT

A washdown system with a hose, nozzle fitting and water supply connection assembly. The hose includes a generally helical central portion and end portions extending generally axially from the central portion. The water supply connection assembly may include female and male portions. The male portion connects to a water supply fitting. When connected to the female portion, the male portion can be swiveled substantially 360°. The female portion may include a quick-disconnect assembly to reversibly couple the male portion.

### CROSS-REFERENCES TO RELATED APPLICATIONS

This application claims priority under 35 U.S.C. §119(e)(2), and hereby incorporates by reference, U.S. Provisional Application No. 60/213,046, filed Jun. 21, 2000.

### BACKGROUND OF THE INVENTION

1. Field of the Invention

This system relates to systems and methods for washing down object surfaces and, in particular, this invention relates to an apparatus and method for delivering water and other cleansing fluids to objects such as automobiles and marine craft.

2. Background of the Invention

It is often desirable that devices and appliances used onboard boats and other watercraft 1) be configured such that they occupy a minimum amount of space when being stored; 2) be easily retrieved for use; 3) be configured to efficiently and effectively fulfill their intended function; and 4) be easily and efficiently stowed away after being used. Equipment used to cleanse the surfaces of boats can be especially troublesome in these respects. Usually a hose and nozzle are used to deliver a directed stream of water over portions of the boat surface. However, after being used, the hose must usually be coiled before being stowed away. The coiled hose inefficiently requires more space than desired when being stored. Moreover, the hose fittings must be threaded onto, and off of, water supply sources when being connected and disconnected. This method is inefficient and time-consuming. Furthermore, a washer or seal must be present in the hose female protector. This seal is easily lost or becomes torn or worn when the hose is being connected and disconnected.

U.S. Pat. No. 5,906,226, issued May 25, 1999 to Goodman, incorporated herein by reference, discloses a very light weight, high-pressure, compact cleaning device for marine and outdoor use. The cleaning device of Goodman delivers water under high pressure via a coiled, retractable hose kit. The coiled hose uses a helical structure to automatically retract when not in use. The helical structure allows the hose to extend substantially the length of a typical fishing boat. A UV and thermal resistant material is used to withstand damage from prolonged exposure to sunlight, heat, and cold. Input and output fittings and a nozzle retention bracket hold the hose structure in a tight helical spring configuration for storage. The light weight of the device purportedly allows easy manipulation of the hose kit and provides improved safety by enhancing the ability to move the hose kit from under foot during periods of intense activity. However, the cleaning device of Goodman must be threaded onto, or off of, a water source in order to be disconnected. Moreover, when stretched out for use, a twisting or torsioning is experienced either on the hose or by the user. Finally, the user experiences a further twisting due to the helical orientation of the nozzle.

U.S. Pat. No. 5,964,412, issued Oct. 12, 1999 to Thomas, incorporated herein by reference, discloses a garden watering system. The garden watering system of Thomas includes an elongate flexible tube formed in extendable and contrastable helical coils with opposed ends. A faucet connector is attached to one end of the tube. A spray nozzle or wand is connected to the opposite end of the tube. However, the garden watering system of Thomas must be threaded and unthreaded to water-providing connections. Moreover, a user will experience twisting and torsioning when the coil is extended.

There is then a need for a washdown device which 1) conserves space when being stored; 2) is extendable over a long distance; 3) is quickly and efficiently connected and disconnected from a water source; 4) does not twist or exert torsioning force on itself when being extended; and 5) does not twist or otherwise tend to strain a user's wrist when being extended as well.

### SUMMARY OF THE INVENTION

The present invention substantially meets the aforementioned needs of the industry by providing a hose assembly. The hose assembly may include a hose body, a fluid supply connection assembly, and an optional nozzle fitting. The hose body may define an inner passageway and may include a central portion and first and second end portions extending from the central portion. The central portion may be configured in a resiliently helical confirmation. The orientations of the first and second end portions may substantially depart from the helical confirmation of the central portion, e.g., axially aligned. The fluid supply connection assembly may be attached to the hose body first end portion and may include a female connector. The female connector may display an interior surface, the interior surface defining a passageway in fluid communication with the hose body passageway. The female connector may include a sliding member biased in a first position. The hose assembly may be detachable from a fluid source by moving the female connector sliding member from the first position to the second position. The optional nozzle fitting may be attachable to the hose body second end portion. The present hose assembly may further include a male connector, the male connector connectable to a source of pressurized fluid and including a tubular member. The tubular member may be accommodated in at least a portion of the female connector passageway. When accommodated and secured within the female connector passageway, the tubular member may be pivoted therein, yet retain a fluid-tight seal.

It is a further object of the present invention to provide a hose assembly, which is resistant to environmental degradation, such as caused by ultraviolet radiation.

It is yet another object of the present invention to provide a hose assembly with a hose of a readily noticeable color.

It is still yet another object of the present invention to provide a hose assembly attachable to a source of pressurized fluid without the necessity of using tools of any sort.

It is still yet another object of the present invention to provide a hose assembly attachable to a source of pressurized fluid without the necessity of threading the hose assembly to, and from, the pressurized source.

It is still yet another object of this invention to provide a hose assembly that eliminates the maintenance required by seals present in the prior art assemblies, which must be threaded on and off pressurized fluid sources.

It is still yet another object of the present invention to provide a hose assembly that occupies a minimum amount of space during storage, that readily assumes a compact confirmation requiring a minimum amount of storage, and is extendable to any desired length.

It is still a further object of the present invention to provide a hose assembly which dissipates the tortional forces generated when the present coiled-hose structure is extended during use, the dissipation by a rotatable, quick-connect assembly.

It is still yet another object of the present invention to provide a hose assembly with end portions deviating substantially from the helical confirmation of the central portion, so that a user's wrist is not strained or otherwise tortionally challenged while using the present invention.

Additional objects, advantages, and features of various embodiments of the present invention will be set forth in part in the description that follows, and, in part, will become apparent to those skilled in the art upon examination of the following or may be learned by practicing the invention. The objects and advantages of various embodiments of the invention may be realized and attained by means of the instrumentalities and combinations particularly pointed out in the appended claims. These and other objects, features, and advantages of this invention will become apparent from the description that follows, when considered in view of the accompanying drawings.

### BRIEF DESCRIPTION OF THE DRAWINGS

FIG. 1 a plan view of the washdown system of this invention;

FIG. 2 is a plan view of the washdown system of FIG. 1, the hose portion in an extended position;

FIG. 3 is a perspective view of a nozzle attached to the washdown system of FIG. 1;

FIG. 4 is a perspective view of the two portions of the water supply connection assembly of this invention;

FIG. 5 is a plan view of the water supply connection assembly of FIG. 4;

FIG. 6 is a plan view of the water supply connection assembly of FIG. 4, a portion thereof depicted in cross section;

FIG. 7 is a cross section of a portion of the water supply connection assembly of FIG. 6 along line 7-7; and

FIG. 8 is a cross section of a portion of the water supply connection assembly of FIG. 4.

### DETAILED DESCRIPTION OF THE INVENTION

Comprehension of this invention can be gained through reference to the drawings in connection with a review of the following explanation. In order to facilitate a full appreciation of this invention, an overview of an exemplary embodiment is provided. The overview is followed by a more detailed explanation.

The present washdown system includes a hose, a male connector for connection to a nozzle or the like, and a connection assembly for connection to a pressurized fluid source such as a water faucet. The hose, or hose body, includes a helical central portion and first and second end portions. The first end portion is connectable (matable) to a male connector, the male connector adapted for threadably connecting to a nozzle or the like. The hose end portions may be axially disposed with respect to the hose helical central portion. The second end portion is connectable (matable) to a quick disconnect assembly. The quick disconnect assembly includes two matable portions. One of the matable portions may be permanently attached to the hose. The other matable portion may be threaded onto a water supply, such as a faucet fixture or seal. The quick connect assembly may swivel or rotate, yet maintain a water-tight connection or seal.

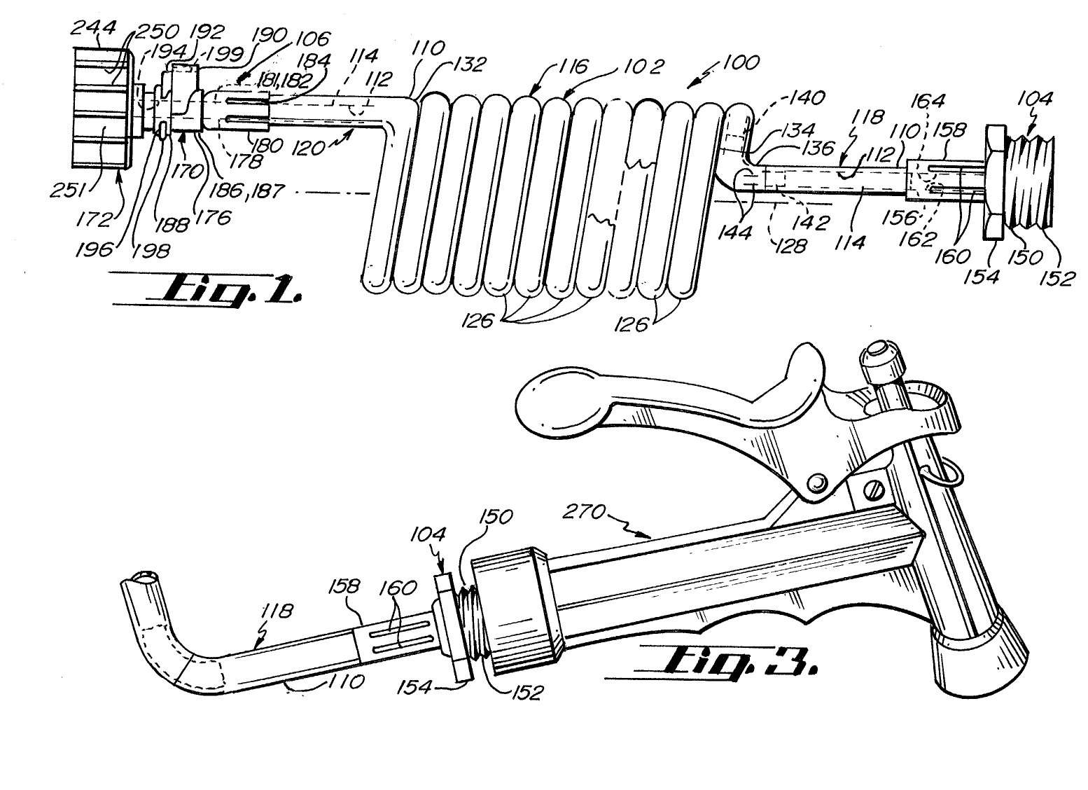

Referring especially to FIGS. 1 and 2, one embodiment of the present washdown assembly is depicted generally at 100 and includes a hose 102, a nozzle fitting 104, and a water supply connection assembly 106. The hose (or hose body), in turn, displays outer and inner surfaces 110 and 112. The inner surface 112 of the hose 102 defines a hose passageway 114. In this embodiment, the present hose 102 is unitary but may be considered as including a generally helical central portion 116 and respective first and second end portions 118 and 120. One suitable material used to make the present hose is UV-resistant polyurethane. In one embodiment, the present urethane hose has an outer diameter of about ½ inch and an inner diameter of about ⅜ inch. One satisfactory polyurethane hose has a Shore A durometer hardness measurement between about 85 and 105, between about 90-100, or about 95. Polyurethanes with such a hardness are considered to provide a desired recoil memory and degree of flexibility in many instances. One such satisfactory polyurethane hose material may be obtained from Coilhose Pneumatics, Inc. East Brunswick, N.J. In one embodiment, the hose material has a readily noticeable color, such as yellow, day-glow orange, day-glow lime, or the like. The presence of a readily noticeable color assists persons in easily identifying the presence of the present invention, e.g., on a cluttered deck, so that they can avoid being tripped or entangled, and also so that the readily apparent hose is identified as being out of place and therefore should be stowed away.

The central portion 116 includes a plurality of substantially helical coils 126 wound about a coil longitudinal axis 128. The above-described materials used in making the present hose may be contemplated to possess the necessary degree of hardness and resilience to return adjacent coils 126 to a close proximity or a generally contacting engagement when not extended during use. For example, a central portion made from the above-described materials, when formed in coils, each coil with an outer diameter of about 4 inches, may be extended over a length of about 15 feet. Yet, when released the central portion coils 126 retract until all or most of the coils come into contact or close proximity. The retracted central portion 116 of an embodiment with an extended length of about 15 feet may be between about 6 inches and 10 inches, any range subsumed therein, or about 8 inches in length. The retracted hose 102 of this length may be between about 20 inches and 28 inches, any range subsumed therein, or about 24 inches.

The first and second end portions 118 and 120 may extend generally axially, or otherwise transversely, from the central portion 116. In one embodiment, the end portions 118 and 120 join the present central portion 116 at a substantially unitary bend 132. Alternatively, the present end portions may be joined to the central portion by using an angular joint 134 (FIG. 1). The exterior of the joint 134 includes a sleeve 136. Internally disposed elements include tubular portions 140 and 142. The tubular portions 140 and 142 may include ribs or teeth to further secure the hose as is known in the art. One or more crimps 144 are placed in the sleeves 136 and 138 to secure the hose and joint 134 in place. The present first and second end portions may extend axially, or otherwise transversely, from the coiled central portion 116. Alternatively, the present first and second end portions may extend at a confirmation substantially departing from the generally helical structure of the present central portion. This departure from the generally helical confirmation prevents strain, fatigue, and perhaps injury to users' wrists, hands, and/or arms, because the generally twisting or otherwise torsional forces applied by totally helical hoses when being used in extended positions are substantially absent or are greatly reduced.

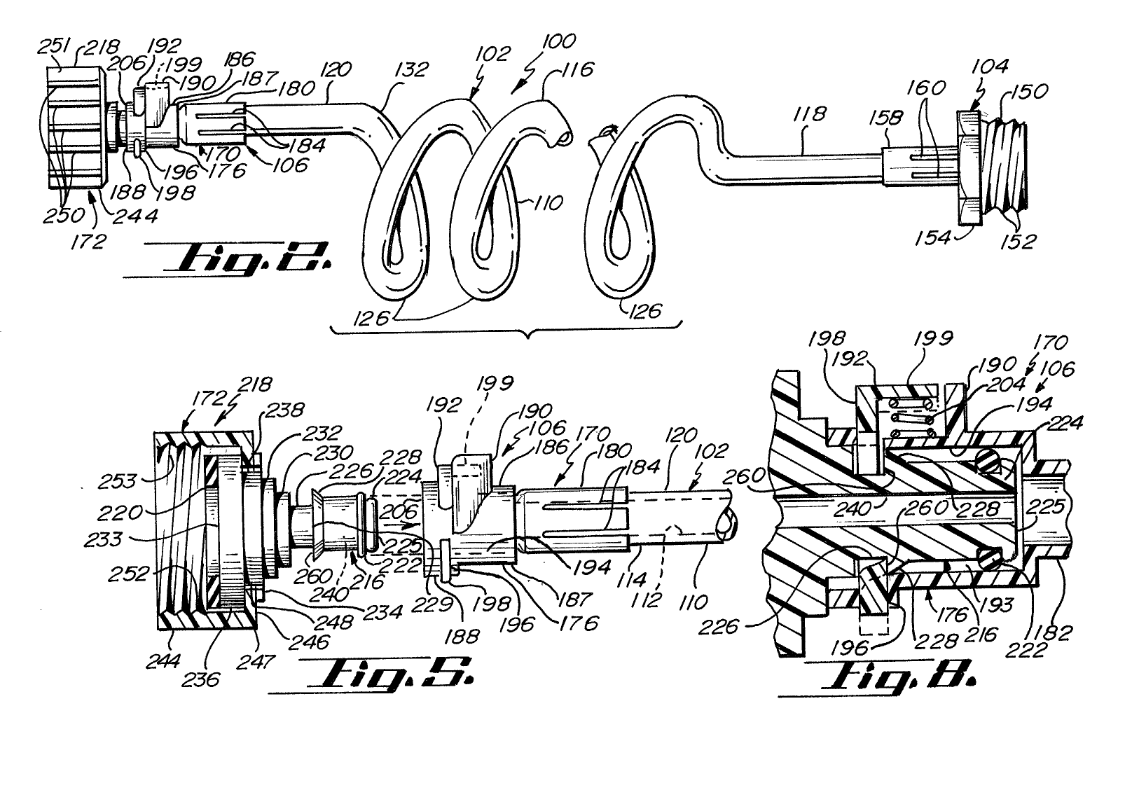

Referring to FIGS. 1-3, the nozzle fitting 104 includes a male portion 150 with threads 152. The male portion 150 extends outboard from a hexagonal structure 154. An inner tubular element 156 extends inboard from the hexagonal structure 154. The inner tubular element 156 may include a plurality of ribs or the like as is known to the art. A sleeve 158 may also extend inboard from the hexagonal structure 154 such that the inner tubular element 156 and the sleeve 158 cooperate to receive the hose material therebetween. When the hose material has been inserted thusly, a plurality of crimps 160 are placed in the outer sleeve 158 to secure the hose in place. A passageway 162 is defined by the interior surface 164 of the inner tubular element 156. When fitted and secured onto the present hose, the passageway 162 is in fluid communication with the hose passageway 114. The nozzle fitting 104 may be made of a plastic such as ABS, polypropylene, or nylon or may be made from metals and may be black or yellow in color. The darker pigments, such as black, may include compounds or other materials to retard or prevent deterioration from sunlight (e.g., UV), cleaning materials, adverse weather or the like. In this embodiment, the male portion 150 is a ¾ inch male adaptor.

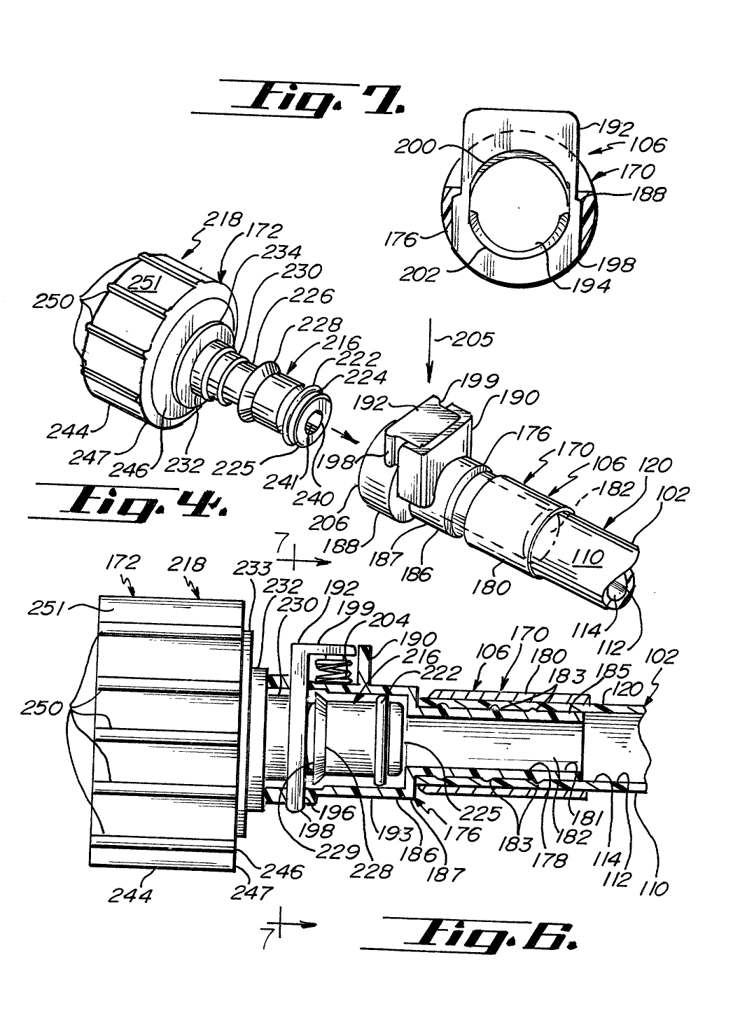

Referring especially to FIGS. 4-8, the water supply connection assembly 106 may include respective female and male connectors 170 and 172. The female connector 170, in turn, includes a connector assembly 176 with an inner tubular element 178 and a sleeve 180 extending generally inboard therefrom. The inner surface 181 of the inner tubular element 178 defines a passageway 182 (FIGS. 1 and 6). When the female connector 170 is connected to the hose of this invention as described hereinbelow, the passageway 182 is in fluid communication with the hose passageway 114. A plurality of ribs 183, or the like, may be present on the outer surface 185 of the inner tubular element 178 to further secure the hose to the connector. The inner tubular element 178 and sleeve 180 are disposed so as to receive the hose, e.g., of the end portion 120, therebetween. The hose is then secured in place by a plurality of crimps 184 in the sleeve 180 (FIGS. 1 and 5).

The connector assembly 176 of this embodiment may be considered to include a unitary body 186 with first and second cylindrical portions 187 and 188 and a shield 190 (FIGS. 4-6). A sliding member 192 may be radially accommodated by the second cylindrical portion 188 and the shield 190 as discussed hereinbelow. Inner surfaces 193 of the cylindrical portions 186 and 188 cooperate to create a passageway 194. The passageway 194 is in fluid communication with the passageway 182 defined by the inner tubular element 178. A generally radial slot 196 may be defined in the second cylindrical portion 188. The slot 196 accommodates a first portion 198 of the sliding member 192. A second portion 199 of the sliding member 192 extends orthogonally, or otherwise transversely, from the first portion 198 and is partially surrounded by the shield 190 when the sliding member 192 is in place. The sliding member first portion 198 defines a first opening 200, which adjoins a second opening 202 (FIG. 7). A cross-sectional dimension, e.g., radius, of the first opening 200 may be larger than a corresponding cross-sectional dimension of the second opening 202. The second portion 199 is biased away from the second cylindrical portion 188 by a biasing member, such as a spring 204. In this embodiment, the spring 204 is disposed between an inner surface of the second portion 199 and an outer surface of the second cylindrical portion 188. When the sliding member 192 is biased as described above, the smaller opening 202 is substantially aligned with the passageway 194. When the second portion 199 is displaced toward the second cylindrical portion 188 in the direction of the arrow 205 (FIG. 4), the larger opening portion 200 is generally aligned with the passageway 194.

An optional male coupling 172 is also provided by the present invention. The male coupling 172 is one embodiment of a fitting which mates and cooperates with the female coupling 170 to allow a substantially 360° rotation, yet to provide a substantially fluid-tight connection or seal. In this embodiment, the male coupling 172 includes a tubular member 216 and a fluid-supply connector 218. A seal (washer) 220 is disposed within the fluid-supply connector 218 to provide a fluid-tight connection when the fluid-supply connector 218 is threaded onto a fluid source, such as a water supply faucet. A seal such as an 0-ring 222 is disposed in an inboard groove 224. The inboard groove 224 is defined proximate an inboard end 225 of the tubular member 216. An outboard groove 226 and a beveled shoulder element such as a flange 228 are also defined in the tubular member 216 outboard of the inboard groove 224. A generally flat surface 229 may extend generally radially between the surface defined by the groove 226 and the flange 228. Respective first and second disc portions 230 and 232 extend generally radially from the tubular member 216 as an outboard end 233 of the tubular member 216 is approached. Respective flanges 234 and 236 are disposed inboard and outboard from a third portion 238. The space between the flanges 234 and 236 accommodates a portion of the female connector 218 as described hereinbelow. A passageway 240 is defined by an interior surface 241 of the tubular member 216. The passageway 240 is in fluid communication with the passageway 194 of the connector assembly 176.

The fluid-supply connector 218 of this embodiment is configured as a cylindrical member 244 and a plate-like, inboard member 246 unitarily extending the inboard end 247 of the cylindrical member 244. An opening 248 is defined in the disc member 246. The opening accommodates the third portion 238 of the tubular member 216. The flange 234 is disposed outboard the disc member 246 and the flange 236 is disposed in the interior of the female connector 218 as shown. The seal 220 is placed inboard, and contacting, the flange 236. The tubular member 216 thus seated, rotates freely within the female connector 218 until the female connector 218 is threaded onto a fluid source. When the female connector 218 is threaded onto a fluid source, the tubular member 216 is usually held in place by the friction generated by the pressure from the threaded connection. A plurality of ribs 250 may be defined on an outer surface 251 of the cylindrical member 244. A plurality of threads 252 are defined in the interior surface 253 of the cylindrical member 244 in this embodiment. As may be the case with the nozzle fitting 104, all or many of the components of the water supply connection assembly 106 may be made from a dark colored (e.g., black) plastic. The black pigmentation, as well as other optional materials known to the art, may impart a resistance to deterioration (e.g., photodecomposition) from ultraviolet radiation. Moreover, the plastic materials provide for lighter weight and are less likely to damage decks and other objects when dropped thereon.

In use, the male connector 172 is threaded to a fluid source, such as a water supply nozzle. The sliding member 192 is depressed and the tubular member 216 is placed inside the passageway 194. Alternatively, the tubular member 216 is inserted without depressing the sliding member 192. When the sliding member 192 is not depressed, the portion of the first portion 198 proximate (e.g., bordering) the first opening 200 contacts the beveled surface 228. As the tubular member 216 is further inserted, the beveled surface 228 displaces the sliding member 192 in the direction of arrow 192 (FIG. 4). When the beveled surface has slid past the sliding member 192, the surface 229 returns to contact the first portion 198 to retain the tabular member 216 in a mated position within the passageway 194 of the female connector 170. When the tubular member 216 is mated in this manner, the O-ring 222 contacts the inner surface of the present female connector passageway and thereby establishes a substantially fluid-tight connection or seal, which remains intact as the tubular member 216 is rotated within the passageway 194. When a user desires to decouple the female and male connectors 170 and 172, the second portion 199 of the sliding member 192 is depressed, removing the first portion 198 from contacting the surface 229 and thereby releasing the tubular member 216. The tubular member 216 can then be withdrawn from the passageway 194.

A nozzle 270 may be threaded onto the nozzle fitting 104 and water under pressure may be released to flow through the washdown assembly 100 to produce a stream of a desired pressure and pattern for use in cleaning, e.g., a boat deck. During use, the hose 102 may be extended by pulling the coils 126 apart (FIG. 2). A twisting or torsional force generated when the present hose central portion is extended will be greatly reduced or totally eliminated because the orientations of the present hose end portions depart from the helical conformation of the hose central portion as described above. Also, because the tubular member 216 can freely rotate within the female connector 170, the torsion generated when the hose is extended is further dissipated when the hose is rotated in response to this torsion.

When the user has completed the washdown task, the pressurized fluid is discontinued and the female coupling 170 is detached from the male coupling 172 by depressing the second portion 199 of the sliding member 192 and pulling the female coupling 170 away from the male coupling 172.

The present invention can be used at several sites without the necessity of threading a male connector 172 to a fluid source at each site. Rather, a male connector 172 may be threaded onto the fluid source at each site. When the user discontinues extending the present hose, the coils draw together, usually until adjacent coils are either in contact or in close proximity. During periods of extremely warm weather, the coils may not resiliently rebound into contact, but usually are within a close proximity, e.g., ¼-½ inch. The extremely compact configuration of the coiled hose makes it easily stored and requires a minimum of space.

While the present invention has been described in connection with marine use, e.g. boat surface washdown, it is obvious that the present invention could also be used at any number of other sites. These other sites include recreational vehicles, home and garden, automotive, industrial, agricultural or the like.

Because numerous modifications of this invention may be made without departing from the spirit thereof, the scope of the present invention is not to be limited to the embodiments described and illustrated herein. Rather, the scope of the invention is to be determined by the appended claims and their equivalents.

What is claimed is:

1. A hose assembly, comprising:
a hose body defining an inner passageway and comprising a central portion and first and second end portions, the central portion in a resiliently helical conformation, the first and second end portions extending from the central portion in first and second orientations, the first and second orientations substantially departing from the helical conformation of the central portion; and
a fluid supply connection assembly attached to the hose body first end portion and comprising a female connector, the female connector with an interior surface defining a passageway, the female connector passageway in fluid communication with the hose body passageway, the female connector comprising a sliding member biased in a first position, said hose assembly detachable from a fluid source by moving the female connector sliding member to a second position.

2. The hose assembly of claim 1, further comprising a nozzle fitting attachable to the hose body second end portion.

3. The hose assembly of claim 2, the female connector sliding member defining adjoining first and second opening portions with respective first and second cross sectional dimensions, the first opening portion cross sectional dimension larger than the second opening cross sectional dimension.

4. The hose assembly of claim 3, the female connector sliding member second opening generally coaxially aligning with the female connector passageway when the female connector sliding member is in the second position.

5. The hose assembly of claim 4, the female connector sliding member first opening generally coaxially aligning with the female connector passageway when the female connector sliding member is in the first position.

6. The hose assembly of claim 5, further comprising a male connector with a tubular member accommodated in at least a portion of the female connector passageway.

7. The hose assembly of claim 6, the tubular member comprising a contact surface contacting the female connector sliding member when the female connector sliding member is in the first position.

8. The hose assembly of claim 3, in which the female connector sliding member moves generally radially to the female connector passageway.

9. The hose assembly of claim 3, the female connector sliding member comprising first and second portions, the female connector sliding member first portion defining the first and second openings, the female connector sliding member second portion extending generally transversely to the female connector sliding member first portion.

10. The hose assembly of claim 9, in which the female connector sliding member second portion extends generally orthogonally from the female connector sliding member first portion.

11. The hose assembly of claim 9, the female connector displaying an outer surface and further comprising a shield extending from the female connector outer surface and at least partially surrounding the female connector sliding member second portion.

12. The hose assembly of claim 2, the female connector further comprising a spring biasing the female connector sliding member in the first position.

13. The hose assembly of claim 2, in which the first and second hose body end portions extend substantially axially from the hose body central portion.

14. The hose assembly of claim 2, further comprising a male connector, the male connector comprising a tubular member rotatively accommodated in at least a portion of the female connector passageway.

15. The hose assembly of claim 14, the male connector further including an annular element disposable about the tubular member.

16. The hose assembly of claim 15, in which the annular element contacts at least a portion of the female connector interior surface to form a fluid-tight seal.

17. The hose assembly of claim 2, in which the hose body is unitary.

18. A method of dispensing a pressurized fluid from a fluid supply source, comprising:
providing a hose assembly comprising a hose body, a fluid supply connection assembly, and a nozzle fitting, the hose body defining an inner passageway and comprising a generally resiliently and helically configured central portion and first and second end portions extending from the hose body central portion, the first and second hose body end portions configured in orientations substantially departing from the helical configuration of the hose body central portion, the fluid supply connection assembly and the nozzle fitting attached to the respective first and second hose body end portions, the fluid supply connection assembly including male and female connectors, the male connector attachable to a fluid supply fitting and comprising a tubular member and a seal disposed about the tubular member, the female connector displaying an inner surface defining an inner passage in fluid communication with the hose body inner passage, at least a portion of the female connector inner passage accommodating the male connector tubular member, the female connector comprising a mechanism for reversibly locking the male connector tubular member into a rotatively sealing contact;
attaching the male connector to the fluid supply fitting;
locking the male connector tubular member in a rotatively sealing contact within the female connector inner passage; and
passing the pressurized fluid through the hose assembly.

19. The method of claim 18, further comprising extending the hose body from the helical configuration.

20. The method of claim 19, in which extending the hose body from the helical configuration generates a torsional force and further comprising rotating the male connector tubular member within the female connector inner passageway to relieve the torsional force.

21. The method of claim 18, the male connector tubular member displaying a beveled surface, the female connector comprising a sliding member, and in which locking the male connector tubular member within the female connector inner passageway includes contacting the beveled surface and the sliding member.

22. The method of claim 21, the female connector sliding member defining adjoining first and second openings and in which locking the male connector tubular member within the female connector inner passageway includes accommodating the male connector tubular member within the second opening.

23. The method of claim 21, the female connector sliding member defining adjoining first and second openings and in which locking the male connector tubular member within the female connector inner passageway includes contacting the male connector tubular member beveled surface to a portion of the female connector member sliding member proximate the second opening.

24. The method of claim 23, the annular surface of the male connector tubular member displaying a radial surface proximate the beveled surface and in which locking the male connector tubular member within the female connector inner passageway comprises contacting the female connector sliding member to the beveled and radial surfaces.

25. The method of claim 24, in which locking the male connector tubular member within the female connector inner passageway further comprises contacting the radial surface of the tubular member and the sliding member.

26. A method of making a hose assembly, comprising:
providing a hose body with a resiliently coiled central portion and first and second end portions extending from the central portion;
connecting a nozzle fitting to the hose body second end portion;
connecting a female connector to the hose body first end portion, the female connector comprising a female connector body and a sliding member, the female connector body defining an inner passage, the sliding member defining adjoining first and second openings with respective first and second cross sectional dimensions, the first cross sectional dimension greater than the second cross sectional dimension, the sliding member generally radially disposed in the female connector body and biased in a position in which the first opening is generally coaxial to the female connector inner passage; and
providing a male connector attachable to a pressurized fluid supply fitting and comprising a tubular member and a seal disposed around the tubular member, the tubular member rotatively accommodated in the female connector passage and displaying an engaging surface, the male connector locked in the female connector passage by contacting the engaging surface and the female connector sliding member.

27. The method of claim 26, in which providing a male connector includes providing a male connector with a threaded portion for attachment to the pressurized fluid supply fitting.

28. A fluid supply connection assembly comprising:
a male connector comprising a threaded cylindrical member, a tubular member, and a sealing member disposed about the tubular member, the cylindrical member for connecting the male connector to a source of pressurized fluid, the tubular member displaying an exterior surface and an interior surface, the exterior surface further displaying a beveled surface portion and a generally radial engagement surface portion proximate the beveled surface portion, the tubular member interior surface defining an inner passage; and
a female connector connectible to a hose and comprising a body and a sliding member radially biased in a first position in the body, the female connector body displaying an inner surface defining an inner passage in fluid communication with the male connector tubular member inner passage and rotationally accommodating at least part of the male connector tubular member, the male connector sealing member contacting the inner surface of the female connector to form a fluid-tight seal, the male connector engagement surface portion contacting the female connector sliding member to reversibly lock the male connector tubular member in the female connector passage.

29. The fluid supply connection assembly of claim 28, the female connector sliding member defining first and second openings with respective first and second cross sectional dimensions, the second cross sectional dimension greater than the first cross sectional dimension.

30. The fluid supply connection assembly of claim 29, in which the first opening coaxially aligns with the female connector passage when the sliding member is in the first position.

31. The fluid supply connection assembly of claim 30, in which the second opening coaxially aligns with the female connector passage when the sliding member is in a second position.

32. The fluid supply connection assembly of claim 31, in which the male connector tubular member beveled surface portion is configured to engage the female connector sliding member proximate the first opening when the male and female connectors are being mated.

33. The fluid supply connection assembly of claim 32, in which the male connector tubular member radial engagement surface portion contacts the female connector sliding member proximate the first opening when the male and female connectors are in a mated position.

34. The fluid supply connection assembly of claim 33, in which the female connector sliding member is slid to the second position to release the male connector from the mated position.
